(19) United States
(12) Patent Application Publication
(10) Pub. No.: US 2017/0252648 A1
(43) Pub. Date: Sep. 7, 2017

(54) STREAMING NARRATIVE EPISODES WITH MICRONARRATIVES TO A NETWORKED DEVICE

(71) Applicant: Tapas Media, Inc., San Francisco, CA (US)

(72) Inventors: Chang Kim, San Francisco, CA (US); Yoon Kim, San Francisco, CA (US); Daron Akira Hall, San Francisco, CA (US)

(73) Assignee: Tapas Media, Inc., San Francisco, CA (US)

(21) Appl. No.: 15/452,327

(22) Filed: Mar. 7, 2017

Related U.S. Application Data
(60) Provisional application No. 62/304,843, filed on Mar. 7, 2016.

(51) Int. Cl. A63F 13/355; A63F 13/537; A63F 13/792; H04L 29/06

(52) U.S. Cl. CPC A63F 13/355; H04L 65/608; A63F 13/537; A63F 13/792

(57) ABSTRACT

Digital readable narrative content comprising written narrative materials for display in a digital format and a macronarrative may be gathered. A user engagement parameter that represents an engagement attribute of a user of a networked device with the digital readable narrative content may be gathered. A first narrative episode within the digital readable narrative content that comprises a first micronarrative, that in turn is part of the macronarrative, and that has a first narrative size based on the user engagement parameter may be selected. One or more first gameplay actions that facilitate one or more first user interactions with the first narrative episode may be associated with the first narrative episode. First streaming blocks that contain the first narrative episode may be created to facilitate streaming the first narrative episode to the networked device.

### CLAIM OF PRIORITY

The present application claims priority to provisional U.S. Patent Application Ser. No. 62/304,843, filed Mar. 7, 2016, to Chang Kim, the contents of which are hereby incorporated by reference herein.

### TECHNICAL FIELD

The technical field relates to streaming digital content delivery and management systems and methods, and more particularly, to systems and methods for streaming narrative episodes of digital readable narrative content to networked devices configured to facilitate user engagement with those streaming narrative episodes.

### BACKGROUND

Digital content delivery systems have the potential to deliver various types of digital content to a wide variety of people. Examples of digital content delivered by such systems include digital books and digital comics, as well as other digital content that can be read on any computer system with a network connection (desktop computer, laptop computer, tablet computing device, mobile phone, Internet of Things (IoT) devices, etc.).

Many digital content delivery systems, such as many existing digital book technologies, require a user to download digital content before granting the user access to the content. While effective for many contexts, existing digital content delivery systems that require downloading digital content presents limitations for many users and/or content publishers. One limitation is that platforms that require downloading content impact storage capabilities of users' devices, particularly when those devices are mobile phones, IoT devices, or other devices with limited storage. Another limitation is that platforms that allow users to download content increases the risk of intellectual property (IP) infringement, theft, and/or piracy, and as a result, may be disfavored by many content publishers.

At least several existing streaming digital content delivery systems allow users to stream and/or buffer portions of digital content to networked devices. Though these systems help with the aforementioned storage and IP issues, existing streaming digital content delivery systems do not effectively engage users or facilitate the sophisticated user interactions with digital content that is possible in other contexts, such as the user interactions present in many social media and/or video game platforms. Existing streaming digital content delivery systems do not create effective incentives to progress through chapters, series, or significant parts of digital books (novels, poems, stories, non-fiction etc.), digital comics, etc. While it would be desirable to increase interactivity with streaming digital readable narrative content to foster engagement with these media, existing streaming digital content delivery systems have not been able to do so.

### SUMMARY

In some implementations, digital readable narrative content comprising written narrative materials for display in a digital format and a macronarrative may be gathered. A user engagement parameter that represents an engagement attribute of a user of a networked device with the digital readable narrative content may be gathered. A first narrative episode within the digital readable narrative content that comprises a first micronarrative, that in turn is part of the macronarrative, and that has a first narrative size based on the user engagement parameter may be selected. One or more first gameplay actions that facilitate one or more first user interactions with the first narrative episode may be associated with the first narrative episode. First streaming blocks that contain the first narrative episode may be created to facilitate streaming the first narrative episode to the networked device.

Disclosed are method(s) being implemented by a computing system including one or more physical processors and storage media storing machine-readable instructions; system(s) comprising at least one processor and a memory storing instructions configured to instruct the at least one processor to perform method(s), and computer storage media storing computer-executable instructions that, when executed, cause a computer system to perform a computer-implemented method. Method(s) may include: gathering digital readable narrative content, the digital readable narrative content comprising written narrative materials for display in a digital format and further comprising a macronarrative; gathering a user engagement parameter for the digital readable narrative content, the user engagement parameter representing an engagement attribute of a user of a networked device with the digital readable narrative content; selecting a first narrative episode within the digital readable narrative content, the first narrative episode comprising a first micronarrative, the first micronarrative being part of the macronarrative, and the first narrative episode having a first narrative size, the first narrative size being based on the user engagement parameter; associating one or more first gameplay actions with the first narrative episode, the one or more first gameplay actions facilitating one or more first user interactions with the first narrative episode; and creating first streaming blocks containing the first narrative episode to facilitate streaming the first narrative episode to the networked device.

The method may further comprise streaming the first narrative episode to the networked device. The first narrative size may be based on one or more of a memory constraint of the networked device, a first estimated user engagement time of the user, and a first actual user engagement time of the user.

The one or more first gameplay actions may be selected based on attributes of the first micronarrative. The one or more first gameplay actions may comprise one or more of: starting to read a portion of the first narrative episode, finishing reading a portion of the first narrative episode, and annotating a portion of the first narrative episode.

The one or more first gameplay actions may comprise achieving a non-reading milestone in the first narrative episode. The one or more first gameplay actions may modify an episode state of the first narrative episode.

Method(s) may further comprise: receiving one or more first user interaction responses corresponding to the one or more first user interactions facilitated by the one or more first gameplay actions from the networked device; and selecting, based on the one or more first user interaction responses, a second narrative episode within the digital readable narrative content, the second narrative episode comprising a second micronarrative, the second micronarrative being part of the macronarrative, the second narrative episode having a second narrative size, and the second narrative size being based on the user engagement parameter.

Method(s) may further comprise: associating one or more second gameplay actions with the second narrative episode, the one or more second gameplay actions facilitating one or more second user interactions with the second narrative episode; and creating second streaming blocks containing the second narrative episode to facilitate streaming the second narrative episode to the networked device.

The first narrative episode and the second narrative episode may form a sequence of narrative episodes, the sequence including a virtual transitional element to transition from the first micronarrative to the second micronarrative. The second narrative size may be based on one or more of a memory constraint of the networked device, a second estimated user engagement time of the user, a second actual user engagement time of the user, and the one or more first user interaction responses.

The one or more second gameplay actions may be selected based on attributes of the second micronarrative. The one or more first user interaction responses may comprise one or more requests to perform a virtual unlocking of the second narrative episode.

The one or more requests to perform the virtual unlocking may comprise requests to redeem virtual goods or virtual currency. The one or more requests to perform the virtual unlocking may comprise one or more requests to buy the second virtual episode. The one or more requests to buy the second virtual episode may comprise one or more requests to spend digital currencies or one or more requests to spend real-life currencies.

The networked device may comprise one or more of a desktop computer, a laptop computer, a tablet computing device, and a mobile phone. The digital readable narrative content may comprise a digital book or a digital comic.

Disclosed are method(s) being implemented by a computing system including one or more physical processors and storage media storing machine-readable instructions; system(s) comprising at least one processor and a memory storing instructions configured to instruct the at least one processor to perform method(s), and computer storage media storing computer-executable instructions that, when executed, cause a computer system to perform a computer-implemented method. Method(s) may include: loading a narrative episode interaction application into dynamic memory of a networked device; gathering a user engagement parameter representing a user engagement attribute of a user of the networked device; receiving first streaming blocks containing a first narrative episode of first digital readable narrative content, the digital readable narrative content comprising written narrative materials for display in a digital format and further comprising a macronarrative, and the first narrative episode comprising a first micronarrative, the first micronarrative being part of the macronarrative, and the first narrative episode having a first narrative size; displaying the first narrative episode in the narrative episode interaction application; receiving one or more first user interaction responses corresponding to the one or more first user interactions facilitated by one or more first gameplay actions in the first narrative episode; and providing the one or more first user interaction responses over a network connection to a streaming digital readable narrative content server.

The first narrative size may be based on one or more of a memory constraint of the networked device, a first estimated user engagement time of the user, and a first actual user engagement time of the user. The one or more first gameplay actions may be selected based on attributes of the first micronarrative.

The one or more first gameplay actions may comprise one or more of: starting to read a portion of the first narrative episode, finishing reading a portion of the first narrative episode, and annotating a portion of the first narrative episode.

The one or more first gameplay actions may comprise one or more of: achieving a non-reading milestone in the first narrative episode. The one or more first gameplay actions may modify an episode state of the first narrative episode.

Method(s) may comprise receiving second streaming blocks containing a second narrative episode within the digital readable narrative content, the second narrative episode being based on the one or more first user interaction responses, the second narrative episode comprising a second micronarrative, the second micronarrative being part of the macronarrative, the second narrative episode having a second narrative size, and the second narrative size being based on the user engagement parameter.

Method(s) may comprise: receiving one or more second user interaction responses corresponding to one or more second user interactions facilitated by one or more second gameplay actions in the second narrative episode; and providing the one or more second user interaction responses over the network connection to the streaming digital readable narrative content server.

The first narrative episode and the second narrative episode may form a sequence of narrative episodes, the sequence including a virtual transitional element to transition from the first micronarrative to the second micronarrative. The second narrative size may be based on one or more of a memory constraint of the networked device, a second estimated user engagement time of the user, a second actual user engagement time of the user, and the one or more first user interaction responses. The one or more first user interaction responses may comprise one or more requests to perform a virtual unlocking of the second narrative episode.

The one or more requests to perform the virtual unlocking may comprise requests to redeem virtual goods or virtual currency. The one or more requests to perform the virtual unlocking may comprise one or more requests to buy the second virtual episode.

The one or more requests to buy the second virtual episode may comprise one or more requests to spend digital currencies or one or more requests to spend real-life currencies. The narrative episode interaction application may comprise a mobile application on a tablet computing device or a mobile phone, or a portion of a website displayed in an Internet browser.

Disclosed are method(s) being implemented by a computing system including one or more physical processors and storage media storing machine-readable instructions; system(s) comprising at least one processor and a memory storing instructions configured to instruct the at least one processor to perform method(s), and computer storage media storing computer-executable instructions that, when executed, cause a computer system to perform a computer-implemented method. Method(s) may include: gathering a user engagement parameter representing a user engagement attribute of a user of a networked device; streaming to a networked device first streaming blocks containing a first narrative episode of first digital readable narrative content, the digital readable narrative content comprising written narrative materials for display in a digital format and further comprising a macronarrative, and the first narrative episode comprising a first micronarrative, the first micronarrative being part of the macronarrative, and the first narrative episode having a first narrative size; receiving one or more first user interaction responses corresponding to the one or more first user interactions facilitated by one or more first gameplay actions in the first narrative episode; and modifying an episodic state of the first narrative episode based on the one or more first user interaction responses.

Other features and implementations may be apparent from the accompanying drawings and from the Detailed Description.

### BRIEF DESCRIPTION OF THE DRAWINGS

FIG. 1 shows an example of a streaming digital readable content environment.

FIG. 2 shows an example of a streaming digital readable content system.

FIG. 3 shows an example of a narrative episode reading engine.

FIGS. 4A and 4B show a flowchart of an example method of streaming one or more narrative episodes to a networked device.

FIGS. 5A and 5B show a flowchart of an example method of facilitating interactions one or more narrative episodes.

FIGS. 6A and 6B show examples of introductory screens of a narrative episode interaction application

FIGS. 7A and 7B show example content selection screens of a narrative episode interaction application.

FIG. 8 shows examples of a virtual currency screen and a virtual key screen of a narrative episode interaction application.

FIG. 9 shows an example of a library screen of a narrative episode interaction application.

FIG. 10 shows examples of user inbox screens of a narrative episode interaction application.

FIG. 11 shows examples of user profile screens of a narrative episode interaction application.

FIG. 12 shows examples of redemption screens of a narrative episode interaction application.

FIG. 13 shows an example of a narrative episode series screen of a narrative episode interaction application.

FIGS. 14A, 14B, and 14C show examples of narrative episode screens, including mechanics to move through narrative episodes, of a narrative episode interaction application.

FIG. 15 shows an example of a computer system.

The figures depict various implementations purposes of illustration only, wherein the figures use like reference numerals to identify like elements. Alternative embodiments of the structures and methods illustrated in the figures may be employed without departing from the principles described herein.

### DETAILED DESCRIPTION

Example System Components

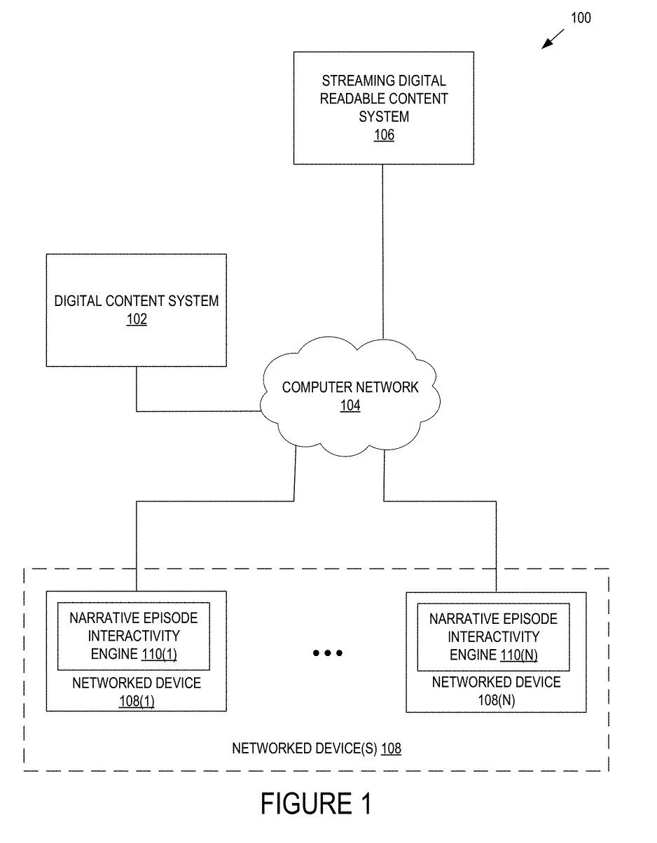

FIG. 1 shows an example of a streaming digital readable content environment 100. The streaming digital readable content environment 100 may include a digital content system 102, a computer network 104, a streaming digital readable content system 106, and one or more networked device(s) 108. The digital content system 102, the streaming digital readable content system 106, and the one or more networked device(s) 108 may be coupled to one another through the computer network 104.

The digital content system 102 may include a computer system configured to store digital readable narrative content and/or provide digital readable narrative content to the other systems over the computer network 104. The digital content system 102 may include one or more “engines” and/or one or more “datastores.” As used herein, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described herein, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The digital content system 102 may include any computer system that is configured to store and/or provide digital content to another computer system. “Digital content,” as used herein, may include any content that exists in the form of digital data. Digital content may be stored on digital formats, analog formats, or some combination thereof. Forms of digital content may include information that is digitally distributed, streamed, or contained in computer files. In some implementations, the digital content stored and/or provided by the digital content system 102 may include digital books, digital comics, digital music, digital video, and/or interactive content.

The computer network 104 and/or other computer readable media discussed in this paper are intended to represent a variety of potentially applicable technologies. For example, the computer network 104 can be used to form a network or part of a network. Where two components are co-located on a device, the computer network 104 can include a bus or other data conduit or plane. Where a first component is co-located on one device and a second component is located on a different device, the computer network 104 can include a wireless or wired back-end network or LAN. The computer network 104 can also encompass a relevant portion of a WAN or other network, if applicable.

The streaming digital readable content system 106 may include a computer system configured to store and/or provide over the computer network 104 digital readable narrative content. More specifically, the streaming digital readable content system 106 may create digital readable narrative content that can be streamed to the networked device(s) 108 in relatively small and potentially connected narrative episodes that each have micronarratives. “Digital readable narrative content,” as used herein, may include digital content that is readable by a user and contains written narrative materials. Examples of digital readable narrative content may include digital books (novels, poems, stories, non-fiction etc.) and digital comics. Digital readable narrative content may have a “macronarrative,” or larger narrative elements that connect the digital readable narrative content into a narrative format.

A “narrative episode,” as used herein, may include a portion of digital readable narrative content that forms a standalone item of digital content for consumption by a reader. A narrative episode may comprise a “micronarrative,” or a smaller narrative element that connects the narrative episode into a narrative format. A micronarrative may be a portion of a larger macronarrative of digital readable narrative content. A narrative episode may include or be associated with virtual items. A “virtual item,” as used herein, may refer to a non-physical item residing within digital content. Virtual items may include “virtual goods,” “virtual keys” (e.g., in-application virtual elements used to unlock or otherwise provide access to narrative episodes), and/or other non-physical goods, “virtual currencies,” or non-physical currencies, and/or other non-physical items in digital content. In some implementations, virtual items may be purchased from online marketplace(s) and/or other users, gifted to/from other users, and/or traded with other users.

Narrative episodes may, but need not, be encoded with gameplay actions, which, as used herein, may actions taken on game-like elements that facilitate user interactions with portions of a narrative episode. The gameplay actions in a narrative episode may include in-episode actions like beginning to read a portion of a narrative episode, finishing reading a portion of a narrative episode, annotating a portion of a narrative episode, and/or interacting with virtual items incorporated in a narrative episode. Gameplay actions may also include out-of-episode actions like redeeming virtual currency, purchasing virtual items, taking social actions (sharing, messaging, etc. other users), or achieving a non-reading milestone.

Narrative episodes may be arranged into a sequence of narrative episodes, where one narrative episode follows another in an order. As noted herein, one narrative episode may be provided in response to gameplay actions taken on another narrative episode. Narrative episodes may be separated by “virtual transitional items,” or virtual items (annotated, curated, etc. introductions, etc.) used to separate one narrative episode from another narrative episode. A narrative episode may have “narrative size(s),” which, as used herein, may refer to a measure of data or a measure of time taken up by the narrative episode. As noted herein, a narrative size may be based on a memory constraint of a networked device and/or a size that allows a narrative episode to reside on a memory-constrained part of storage of a networked device. A narrative size may also be based on engagement time(s) of users, including but not limited to an estimated user engagement time of a user or an actual user engagement time of a user (such as the user engagement time a user engaged with another narrative episode).

As discussed in detail herein, streaming narrative episodes may address technical problems of accommodating limited storage capabilities as well as technical problems of protecting the integrity of licenses to digital content that platforms that required downloading content presented. In some implementations, narrative episodes may be incorporated into streaming blocks, which, as used herein, may include portions of the narrative episode transformed into a format that can be accessed in substantially real-time at a remote device.

The streaming digital readable content system 106 may use video game-based mechanics to interact with digital readable narrative content. Video game-like user interactions with narrative episodes, with other users, with virtual items/virtual goods/virtual currency, etc. may be identified and may form the basis of user engagement parameters. A “user engagement parameter,” as used herein, may include a parameter that represents an engagement attribute with digital content, such as digital readable narrative content or a narrative episode. User engagement parameters may be based on times users interact with digital content, specific combinations of interactions with virtual items in digital content, attributes of a device used to access digital content, etc.

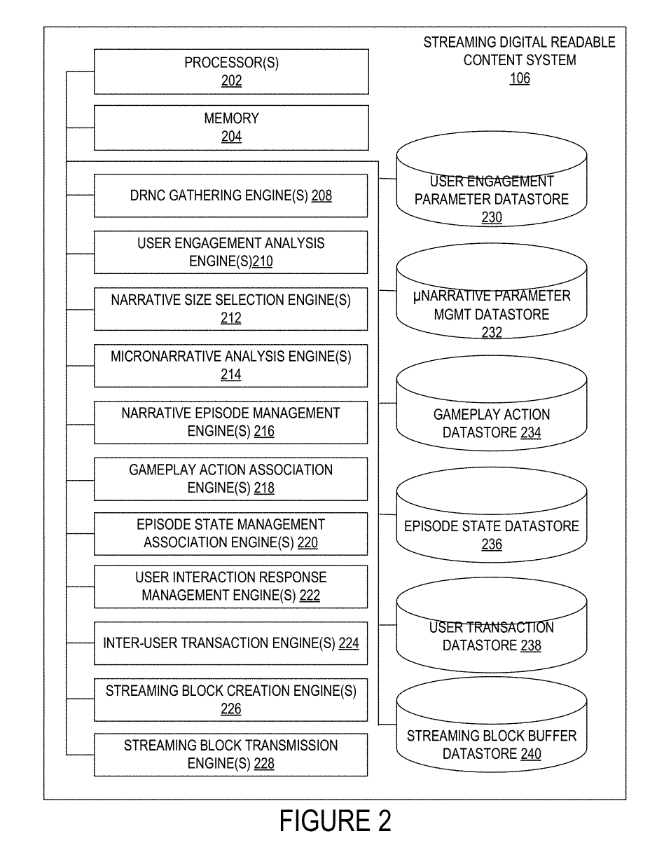

In some implementations, the streaming digital readable content system 106 may use user engagement parameters to provide a basis for additional narrative episodes. In some implementations, the episodic state(s) of narrative episodes may be modified with video game-like user interactions with these narrative episodes. An “episodic state,” as used herein, may refer to a state of a narrative episode, and may represent any attribute of interaction with a narrative episode. Episodic states may include whether a narrative episode has been started or finished by a user, how far into a narrative episode a user has gotten, interaction with one or more virtual items in a narrative episode, and/or any other state of a narrative episode. Episodic state(s) of a narrative episode may also be changed with gameplay actions taken on the narrative episode, as discussed further herein. FIG. 2 shows an example of the streaming digital readable content system 106 in greater detail.

The networked device(s) 108 (shown in FIG. 1 as a networked device 108(1) through a networked device 108(N)) may include a computer system configured to facilitate user interactions with digital readable narrative content. The networked device(s) 108 may comprise a computer system (desktop computer, laptop computer, tablet computing device, mobile phone, Internet of Things (IoT) devices, etc.) that can be coupled to the computer network 104.

The networked device(s) 108 include respective narrative episode interactivity engine(s) 110 (shown in FIG. 1 as a narrative episode interactivity engine(s) 110(1) through a narrative episode interactivity engine(s) 110(N)). The narrative episode interactivity engine(s) 110 may constitute one or more engines and may comprise one or more datastores, as described in greater detail herein. In some implementations, the narrative episode interactivity engine(s) 110 support a narrative episode interaction application. A “narrative episode interaction application,” as used herein, may include an application loaded into memory of the networked device(s) 108 and supported by one or more processors of the networked device(s) 108 that facilitates user interactions with digital readable narrative content and/or one or more narrative episodes of digital readable narrative content.

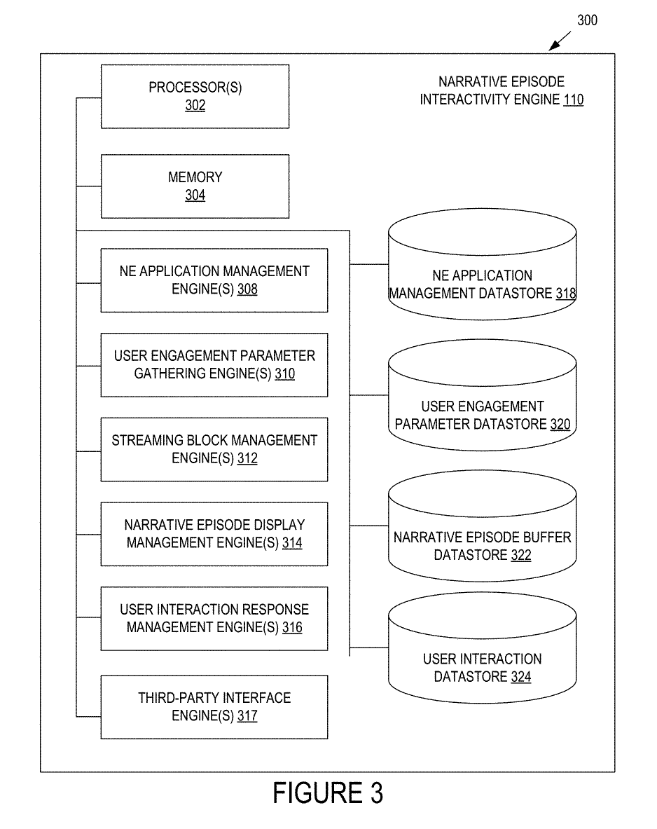

In some implementations, the narrative episode interactivity engine(s) 110 receives streaming narrative episodes over the computer network 104, and/or loads these narrative episodes into the narrative episode interaction application. The narrative episode interactivity engine(s) 110 may further display narrative episodes, along with virtual items, in the narrative episode interaction application. The narrative episode interactivity engine(s) 110 may allow users to interact with narrative episodes, by, e.g., reading them, interacting with virtual items embedded in them, sharing them, taking gameplay actions embedded in them, etc. These interactions may form the basis of user interaction responses that the narrative episode interactivity engine(s) 110 may provide to the streaming digital readable content system 106 over the computer network 104. FIG. 3 shows an example of the narrative episode interactivity engine(s) 110 in greater detail.

FIG. 2 shows an example of the streaming digital readable content system 106. The streaming digital readable content system 106 may include one or more processor(s) 202, memory 204, digital readable narrative content gathering engine(s) 208, user engagement analysis engine(s) 210, narrative size selection engine(s) 212, micronarrative analysis engine(s) 214, narrative episode management engine(s) 216, gameplay action association engine(s) 218, episode state management engine(s) 220, user interaction response management engine(s) 222, inter-user transaction engine(s) 224, streaming block creation engine(s) 226, and streaming block transmission engine(s) 228, a user engagement parameter datastore 230, a micronarrative parameter management datastore 232, a gameplay action datastore 234, an episode state datastore 236, a user transaction datastore 238, and a streaming block buffer datastore 240. The components shown in FIG. 2 may be coupled to one another and/or to modules not explicitly shown.

The digital readable narrative content gathering engine(s) 208 may comprise engine(s) configured to gather digital readable narrative content from the digital content system 102. In some implementations, the digital readable narrative content gathering engine(s) 208 may support one or more interfaces with the digital content system 102. For example, in these implementations, the digital readable narrative content gathering engine(s) 208 may instruct the digital content system 102 to transfer some or all digital readable narrative content at the streaming digital readable content system 106. It is noted that digital readable narrative content need not be stored locally in various embodiments, and that the digital readable narrative content gathering engine(s) 208 may instruct the streaming digital readable content system 106 to provide access to specified portions (e.g., specified digital book and/or digital comic chapters, specified pages, etc.) of digital readable narrative content. The digital readable narrative content gathering engine(s) 208 may provide digital readable narrative content to other modules referenced herein.

The user engagement analysis engine(s) 210 may comprise engine(s) configured to gather user engagement parameters from the user engagement parameter datastore 230 and/or perform analyses of these user engagement instructions. As noted herein, user engagement parameters gathered may, but need not, represent engagement attributes of users of the networked device(s) 108 with digital readable narrative content. The engagement attributes may represent various facets of potential or actual user engagement with digital readable narrative content. The engagement parameter may represent, for instance an estimate of engagement time of a user with specific digital readable narrative content or with digital readable narrative content generally. The estimate may be derived from past user interactions with digital readable narrative content, other actions taken by the user, attributes of a user's social profile, etc. As another example, the engagement parameter may represent actual engagement time of a user with a digital readable narrative content item. The user engagement parameters may form the basis for further analysis performed by other modules referenced herein.

The narrative size selection engine(s) 212 may comprise engine(s) configured to gather narrative size(s) of narrative episodes from the micronarrative parameter management datastore 232. The narrative size selection engine(s) 212 may also be configured to facilitate selection of narrative size(s) of narrative episodes. Narrative size(s) may depend on various factors, including but not limited to memory constraints of the networked device(s) 108. As an example, the narrative size selection engine(s) 212 may select narrative size(s) to accommodate the limited memory of mobile phones, IoT devices, and/or tablet computing devices. Such selections may facilitate reading digital readable narrative content on storage-constrained devices. An another example, the narrative size selection engine(s) 212 may select narrative size(s) on estimated or actual engagement times of users. Narrative size(s) may be directly or indirectly derived from user engagement parameters gathered by the user engagement analysis engine(s) 210. The micronarrative analysis engine(s) 214 may comprise engine(s) configured to gather micronarrative parameters and/or otherwise analyze micronarratives in digital readable narrative content. In some implementations, the micronarrative analysis engine(s) 214 uses user engagement parameters, narrative size(s), and/or other data to identify parameters of micronarratives of digital readable narrative content.

The narrative episode management engine(s) 216 may comprise engine(s) configured to select narrative episode(s) for digital readable narrative content. The narrative episode management engine(s) 216 may use user engagement parameters, narrative size(s), micronarrative parameters, and/or other data to select narrative episodes for a user. Advantageously, narrative episode(s) selected by the narrative episode management engine(s) 216 may be customized to various attributes and/or preferences of a user, such as memory constraints of networked device(s) 108, past user interactions with narrative episodes, estimated and/or actual user engagement parameters, social attributes (shares, messages, likes, etc.) of users, etc. The narrative episode management engine(s) 216 may provide selected narrative episode(s) to other modules. In some implementations, the narrative episode management engine(s) 216 provides a plurality of narrative episode(s) in a series having an order relevant to a user's experience with digital readable narrative content.

The gameplay action association engine(s) 218 may comprise engine(s) configured to associate gameplay actions with narrative episodes. The gameplay action association engine(s) 218 may gather gameplay action data from the gameplay action datastore 234. The gameplay action association engine(s) 218 may include one or more game engines that render graphics, perform functions of physics engines and/or collision detection engines, sound engines, scripting engines, animation engines, artificial intelligence engines, and may include video support for cinematic effects in some implementations. As noted herein, the gameplay data gathered by the gameplay action association engine(s) 218 may include specific movements (gestures, etc.) and/or combinations thereof, specific user interactions taken on narrative episodes and/or virtual items internal to or external to narrative episodes, data related to virtual currency and/or virtual keys used to unlock/access/etc. narrative episodes. The gameplay data may be configured to be modified based on user engagement parameters. In some implementations, the gameplay action data includes social user interactions, such as likes, shares, and/or messages related to narrative episodes. The gameplay action association engine(s) 218 may incorporate gameplay actions with portions of narrative episode(s).

The episode state management engine(s) 220 may comprise engine(s) configured to manage episodic states of narrative episodes. The episode state management engine(s) 220 may gather episodic state(s) of narrative content from episode state datastore 236, may modify the episodic state(s) with gameplay actions and/or user interactions processed by the user interaction response management engine(s) 222. The episode state management engine(s) 220 may store modified episodic state(s) in the episode state datastore 236.

The user interaction response management engine(s) 222 may comprise engine(s) configured to process user interaction responses to narrative episodes, including user responses to gameplay actions. In some implementations, the user interaction response management engine(s) 222 provide user interaction responses to other modules.

The inter-user transaction engine(s) 224 may comprise engine(s) configured to process user transactions. The inter-user transaction engine(s) 224 may interface with account data on an application store. In some implementations, the inter-user transaction engine(s) 224 reconciles amounts of virtual currencies, virtual items and/or other items between users or between user's accounts on an application store.

The streaming block creation engine(s) 226 may comprise engine(s) configured to create streaming blocks to stream narrative episodes and/or other parts of digital readable narrative content. The streaming block transmission engine(s) 228 may comprise engine(s) configured to transmit streaming blocks associated with narrative episodes and/or other parts of digital readable narrative content to networked device(s) 108.

The user engagement parameter datastore 230 may be configured to store user engagement parameters. The user engagement parameters may comprise estimated and/or actual time(s) of user engagement, specific responses to virtual items, specific user interactions taken against narrative episodes, and/or other user engagement parameters. The user engagement parameter datastore 230 may store user engagement parameters on a per-user basis, on a per device basis, or in some other format that can be analyzed by the user engagement analysis engine(s) 210.

The micronarrative parameter management datastore 232 may be configured to store parameters of micronarratives. The micronarrative parameter management datastore 232 may be configured to narrative time(s)/length(s), narrative size(s), and/or other parameters of micronarratives. In some implementations, the parameters in the micronarrative parameter management datastore 232 are populated based on user engagement parameters of a specific user.

The gameplay action datastore 234 may be configured to store gameplay action data for narrative episodes. Gameplay action data may include specific movements (gestures, etc.) and/or combinations thereof, specific user interactions taken on narrative episodes and/or virtual items internal to or external to narrative episodes. In various implementations, the gameplay action data includes data related to virtual currency and/or virtual keys used to unlock/access/etc. narrative episodes. The gameplay data may, but need not, be modified based on user engagement parameters. In some implementations, the gameplay action data includes social user interactions, such as likes, shares, and/or messages related to narrative episodes.

The episode state datastore 236 may be configured to store episodic state(s) of narrative episodes, such as whether a user has unlocked, accessed, started, or ended a narrative episode, whether a user has performed user interactions against virtual items in a narrative episode, etc. The user transaction datastore 238 may be configured to store user transaction data, such as a user's virtual currencies, virtual keys, and/or other attributes of a user's account. The user transaction datastore 238 may be populated or backed by virtual or real-world consideration from an application store (e.g., the iTunes® store, the Google Play® store, etc.). In some implementations, the user transaction datastore 238 stores reconciliation amounts between users, such as virtual currency balances, virtual key balances, other virtual item balances, etc. between users. The streaming block buffer datastore 240 may be configured to store streaming blocks used to load a narrative episode into the memory 204.

FIG. 3 shows an example of a narrative episode interactivity engine 110. The narrative episode interactivity engine 110 may include one or more processor(s) 302, memory 304, narrative episode (NE) application management engine(s) 308, user engagement parameter gathering engine(s) 310, streaming block management engine(s) 312, narrative episode display management engine(s) 314, user interaction response management engine(s) 316, third-party interface engine(s) 317, a narrative episode (NE) application management datastore 318, a user engagement parameter datastore 320, a narrative episode buffer datastore 322, and a user interaction datastore 324. The components shown in FIG. 3 may be coupled to one another and/or to modules not explicitly shown.

The NE application management engine(s) 308 may comprise engine(s) configured to manage a narrative episode interaction application. In some implementations, the NE application management engine(s) 308 loads the NE application management engine(s) 308 load a narrative episode interaction application into dynamic memory of the narrative episode interactivity engine 110 and/or the networked device(s) 108. The NE application management engine(s) 308 may also manage general startup, memory, and/or exit process of a narrative episode interaction application. In some implementations, the narrative episode interaction application may comprise a mobile application on a tablet computing device or a mobile phone, or a portion of a website displayed in an Internet browser

The user engagement parameter gathering engine(s) 310 may comprise engine(s) configured to gather one or more user engagement parameters from the user engagement parameter datastore 320. One or more of the user engagement parameters may represent user engagement attributes of a user of the networked device(s) 108. The user engagement parameter gathering engine(s) 310 may provide the user engagement parameters to one or more other modules of the narrative episode interactivity engine 110.

The streaming block management engine(s) 312 may comprise engine(s) configured to receive streaming blocks that contain narrative episodes of digital readable narrative content. The streaming block management engine(s) 312 may gather buffered streaming blocks from the narrative episode buffer datastore 322.

The narrative episode display management engine(s) 314 may comprise engine(s) configured to display narrative episode(s) in a narrative episode interaction application. The narrative episode display management engine(s) 314 may provide instructions to a display of the networked device(s) 108 to display narrative episode(s). The narrative episode display management engine(s) 314 may monitor user interface elements (such as those incorporated in touchscreen displays, input devices, etc.) for sequences of user movements/actions/etc. that correspond to instructions to interact with a narrative episode interaction application. The narrative episode display management engine(s) 314 may provide instructions to manage narrative episode(s) displayed in a narrative episode interaction application, including instructions to modify an episodic state of narrative episodes.

The user interaction response management engine(s) 316 may comprise engine(s) configured to receive user interaction responses to narrative episodes. In some implementations, the user interaction responses may comprise user responses to gameplay actions for virtual items in narrative episode(s). As examples, the user interaction responses may comprise requests to start a narrative episode, unlock a narrative episode using a virtual item, turn pages of a narrative episode, end a narrative episode, etc. The user interaction response management engine(s) 316 may provide user interaction responses to other modules of the narrative episode interactivity engine 110.

The third-party interface engine(s) 317 may comprise engine(s) configured to interface with third-party applications, such as messaging applications, social media applications, third-party plugins, etc.

The NE application management datastore 318 may comprise a datastore configured to support a narrative episode interaction application. The NE application management datastore 318 may include application startup data, memory management data, etc. The NE application management datastore 318 may also

The user engagement parameter datastore 320 may comprise a datastore configured to store user engagement parameters. Each user engagement parameter may represent user engagement attribute(s) of a user of the networked device(s) 108. The user engagement parameters may comprise estimated and/or actual time(s) of user engagement, specific responses to virtual items, specific user interactions taken against narrative episodes, and/or other user engagement parameters. The user engagement parameter datastore 320 may store user engagement parameters on a per-user basis, on a per device basis, or in some other format that can be analyzed by the user engagement parameter gathering engine(s) 310.

The narrative episode buffer datastore 322 may comprise a datastore configured to buffer streaming blocks representing one or more narrative episodes. In various implementations, the narrative episode buffer datastore 322 includes dynamic and/or volatile memory to store streaming blocks that represent one or more narrative episodes. The narrative episode buffer datastore 322 may provide a narrative episode that has been buffered to the other modules of the networked device(s) 108.

The user interaction datastore 324 may comprise a datastore configured to store user interaction data, including but not limited to user interactions with narrative episodes and/or user interactions (including but not limited to those associated with gameplay actions) with virtual currencies, virtual keys, and/or other virtual items associated with narrative episodes.

### Example System Components in Operation

The systems, methods, and computer-readable media described herein present technical solutions to technical problems associated with streaming digital content delivery systems. In some implementations, systems, methods, and computer-readable media described herein may solve technical problems of user engagement with digital readable narrative content by using video game-based mechanics to interact with digital readable narrative content.

The components of the streaming digital readable content environment 100 may operate to stream narrative episodes of digital readable narrative content to the networked device(s) 108. In some implementations, one or more components of the streaming digital readable content system, such as the digital readable narrative content gathering engine(s) 208, may operate to gather digital readable narrative content from the digital content system 102. The digital readable narrative content may comprise written narrative materials for display in a digital format (e.g., in any format that can be viewed on a digital display of the networked device(s) 108 and/or supported by the narrative episode interactivity engine 110. The digital readable narrative content may comprise a macronarrative, such as a narrative that is common to multiple portions of the digital readable narrative content.

The user engagement analysis engine(s) 210 may operate to gather from the user engagement parameter datastore 230 one or more user engagement parameters for the digital readable narrative content. The one or more user engagement parameters may represent engagement attributes of a user of the networked device(s) 108 with the digital readable narrative content. The one or more user engagement parameters may be based on times users of the networked device(s) 108 have interact with, are interacting with, and/or will interact with digital content (including digital readable narrative content). In some implementations, the user engagement parameters may comprise combinations of interactions with virtual items in digital content, attributes of the networked device(s) 108 (memory, network capabilities, etc.), etc.

The narrative size selection engine(s) 212 may operate to select a first narrative size based on the user engagement parameter. The first narrative size may be based on attributes of a user and/or attributes of the networked device(s) 108. As examples, the first narrative size may be based on one or more of a memory constraint of the networked device(s) 108, a first estimated user engagement time of the user, and a first actual user engagement time of the user. Estimated user engagement time(s) and/or the first actual user engagement time of the user may be gathered using the techniques described herein. The micronarrative analysis engine(s) 214 may operate to gather first micronarrative parameters from the micronarrative parameter management datastore 232. The first micronarrative parameters may be based on the user engagement parameters gathered by the user engagement analysis engine(s) 210. The micronarrative analysis engine(s) 214 may provide the first micronarrative parameters to the narrative episode management engine(s) 216. The narrative episode management engine(s) 216 may operate to select a first narrative episode having the first narrative size and comprising the first micronarrative. The narrative episode management engine(s) 216 may store the first narrative episode and/or provide the first narrative episode to other modules.

The gameplay action association engine(s) 218 may operate to associate one or more first gameplay actions with the first narrative episode. The one or more first gameplay actions may be gathered from the gameplay action datastore, and may comprise virtual items, including virtual currencies, virtual keys, and/or other virtual items. In some implementations, the gameplay action association engine(s) 218 may operate to associate the first gameplay actions with other parts of the digital readable narrative content, such as portions of the digital readable narrative content that do not include the first narrative episode; such implementations allow virtual items be used to facilitate access to narrative episodes of digital readable narrative content that a user has not yet obtained access to. In various implementations, the one or more first gameplay actions are selected based on attributes of the micronarrative. The one or more first gameplay actions may be selected based on starting to read a portion of the first narrative episode, finishing reading a portion of the first narrative episode, and annotating a portion of the first narrative episode, etc. In some implementations, the one or more first gameplay actions comprise achieving a non-reading milestone in the first narrative episode. Examples of non-reading milestones including sharing the first narrative episode with other users, making in-narrative episode purchases, and making out-of-narrative episode purchases. The one or more first gameplay actions may modify an episodic state of the first narrative.

The streaming block creation engine(s) 226 may operate to create first streaming blocks containing the first narrative episode to facilitate streaming the first narrative episode to the networked device(s) 108. In some implementations, the streaming block transmission instructions may operate to stream the first narrative episode to the networked device(s) 108.

The narrative episode interactivity engine 110 may operate to facilitate first user interaction responses to the first narrative episode. The NE application management engine(s) 308 may operate to load a narrative episode interaction application into dynamic memory and/or other processes of the networked device(s) 108. The streaming block management engine(s) 312 may operate to receive the first streaming blocks of the digital readable narrative content. The first streaming blocks may contain the first narrative episode. A first narrative size of the first narrative episode may be based on one or more of a memory constraint of the networked device, a first estimated user engagement time of the user, and a first actual user engagement time of the user.

The user engagement parameter gathering engine(s) 310 may gather one or more user engagement parameters representing a user engagement attribute of a user of the networked device(s) 108. The narrative episode display management engine(s) 314 may operate to display the first narrative episode in the narrative episode interaction application managed by the NE application management engine(s) 308. The user interaction response management engine(s) 316 may operate to receive one or more first user interaction responses corresponding to the one or more first user interactions facilitated by one or more first gameplay actions in the first narrative episode.

The first user interactions may comprise one or more requests to perform a virtual unlocking of the second narrative episode. As an example, the first user interactions may comprise requests to redeem virtual currencies, virtual items, and/or take actions on virtual items on the first narrative episode in order to unlock the second narrative episode. E.g., the one or more requests to perform the virtual unlocking may comprise requests to redeem virtual goods or virtual currency. As additional examples, the one or more requests to perform the virtual unlocking may comprise one or more requests to buy the second virtual episode. The one or more to buy the second virtual episode may comprise one or more requests to spend digital currencies or one or more requests to spend real-life currencies.

The user interaction response management engine(s) 222 may operate to receive the first user interactions facilitated by the one or more first gameplay actions from the networked device(s) 108. The narrative episode management engine(s) 216 may operate to select, based on the one or more first user interactions, a second narrative episode within the digital readable narrative content. In various implementations, the first narrative episode and the second narrative episode form a sequence of narrative episodes, the sequence including a virtual transitional element to transition from the first micronarrative to the second micronarrative. In some implementations, the second narrative episode may comprise a second micronarrative that is part of the larger macronarrative of the digital readable narrative content. The second narrative episode may have a second narrative size that may, but need not, be based on the user engagement parameter of the user of the networked device(s) 108. In some implementations, the second narrative size may be based on one or more of a memory constraint of the networked device, a second estimated user engagement time of the user, a second actual user engagement time of the user, and the one or more first user interaction responses.

In some implementations, the gameplay action association engine(s) 218 may associate one or more second gameplay actions with the second narrative episode. The one or more second gameplay actions facilitating one or more second user interactions with the second narrative episode. In some implementations, the first narrative episode and the second narrative episode form a sequence of narrative episodes, the sequence including a virtual transitional element to transition from the first micronarrative to the second micronarrative. In some implementations, the one or more second gameplay actions may be selected based on attributes of the second micronarrative.

In some implementations, the streaming block management engine(s) 312 may receive second streaming blocks containing a second narrative episode within the digital readable narrative content. The second narrative episode may be based on the one or more first user interaction responses. The second narrative episode comprise the second micronarrative. The second micronarrative may be part of the macronarrative, the second narrative episode having a second narrative size, and the second narrative size being based on the user engagement parameter.

The user interaction response management engine(s) 316 may operate to receive one or more second user interaction responses corresponding to one or more second user interactions facilitated by one or more second gameplay actions in the second narrative episode. The NE application management engine(s) 308 may operate to provide the one or more second user interaction responses over the network connection to the streaming digital readable narrative content server.

### Example Flowcharts of Methods of Operation

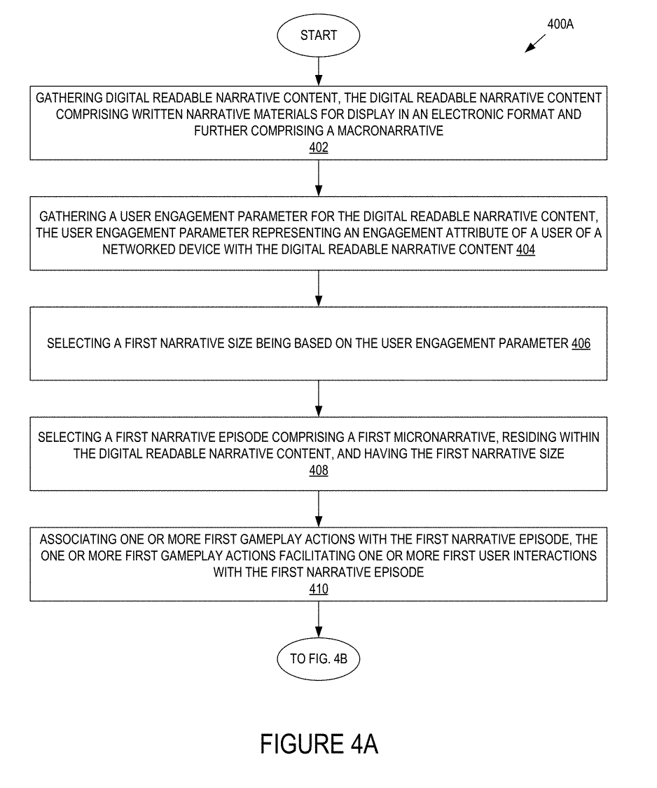

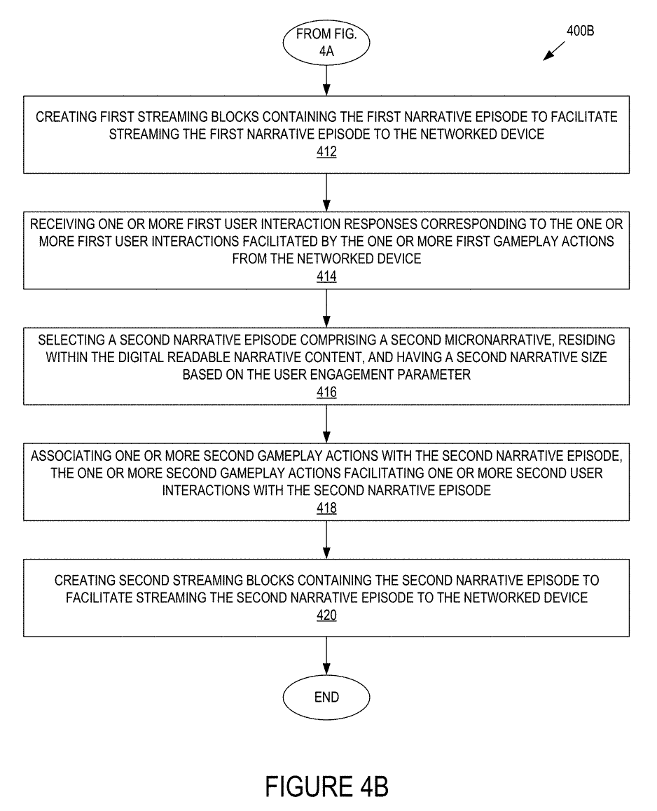

FIGS. 4A and 4B show a flowchart 400 of an example method of streaming one or more narrative episodes to a networked device(s) 108. The method is shown in conjunction with the structures of the streaming digital readable content system 106, shown in FIGS. 1 and 2 and discussed further herein. It is noted the method may have additional or fewer operations than those shown in FIGS. 4A and 4B. Additionally, it is noted that structures other than those shown in FIGS. 1 and 2 may perform the operations shown in FIGS. 4A and 4B.

At an operation 402, digital readable narrative content may be gathered. The digital readable narrative content may comprise written narrative materials for display in an electronic format and may further comprise a macronarrative. In some implementations, the digital readable narrative content gathering engine(s) 208 may gather from the digital content system 102 digital readable narrative content, as discussed further herein.

At an operation 404, a user engagement parameter for the digital readable narrative content may be gathered. The user engagement parameter may represent an engagement attribute of a user of a networked device with the digital readable narrative content. The user engagement analysis engine(s) 210 may gather from the user engagement parameter datastore 230 a user engagement parameter for the digital readable narrative content.

At an operation 406, a first narrative size being based on the user engagement parameter may be selected. The narrative size selection engine(s) 212 may use the user engagement parameters gathered by the user engagement analysis engine(s) 210 to select a first narrative size.

At an operation 408, a first narrative episode comprising a first micronarrative, residing within the digital readable narrative content, and having the first narrative size may be selected. The micronarrative analysis engine(s) 214 may identify micronarratives using the micronarrative parameter management datastore 232. The narrative episode management instructions may select a first narrative episode from the digital readable narrative content with the micronarrative and having the first narrative size.

At an operation 410, one or more first gameplay actions may be associated with the first narrative episode. The one or more first gameplay actions may facilitate one or more first user interactions with the first narrative episode. In various implementations, the gameplay action association engine(s) 218 may associate one or more first gameplay actions with the first narrative episodes. These first gameplay actions may be gathered from the gameplay action datastore 234, and may be associated with virtual items and/or other in-game elements to associate with the first narrative episode.

At an operation 412, first streaming blocks containing the first narrative episode may be created to facilitate streaming the first narrative episode to the networked device(s) 108. The streaming block creation engine(s) 226 may create first streaming blocks that contain the first narrative episode. The streaming block transmission engine(s) 228 may configure network interface(s) of the streaming digital readable content system 106 to provide the first streaming blocks to the networked device(s) 108.

At an operation 414, one or more first user interaction responses corresponding to the one or more first user interactions facilitated by the one or more first gameplay actions from the networked device may be received. In various implementations, the user interaction response management engine(s) 222 may receive one or more first user interaction responses from the networked device(s) 108. The first user interaction responses may correspond to the one or more first user interactions facilitated by the one or more first gameplay actions from the networked device may be received.

At an operation 416, a second narrative episode comprising a second micronarrative, residing within the digital readable narrative content, and having a second narrative size based on the user engagement parameter may be selected. The narrative episode management engine(s) 216 may select a second narrative episode comprising a second micronarrative, residing within the digital readable narrative content, and having a second narrative size based on the user engagement parameter.

At an operation 418, one or more second gameplay actions may be associated with the second narrative episode. In some implementations, the one or more second gameplay actions may facilitate one or more second user interactions with the second narrative episode. The gameplay action association engine(s) 218 may associate one or more second gameplay actions with the second narrative episode.

At an operation 420, second streaming blocks containing the second narrative episode may be created to facilitate streaming the second narrative episode to the networked device. The streaming block creation engine(s) 226 may create second streaming blocks that contain the second narrative episode. The streaming block transmission engine(s) 228 may configure network interface(s) of the streaming digital readable content system 106 to provide the second streaming blocks to the networked device(s) 108.

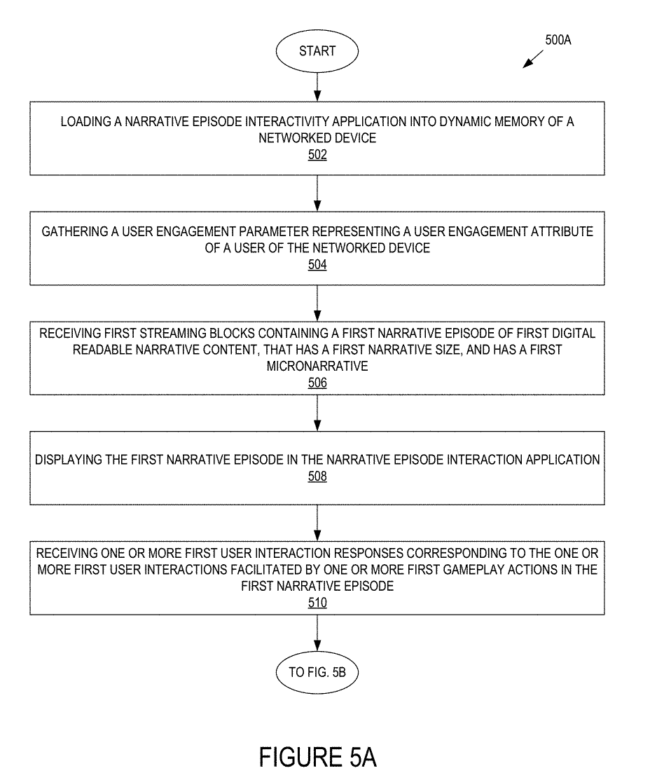

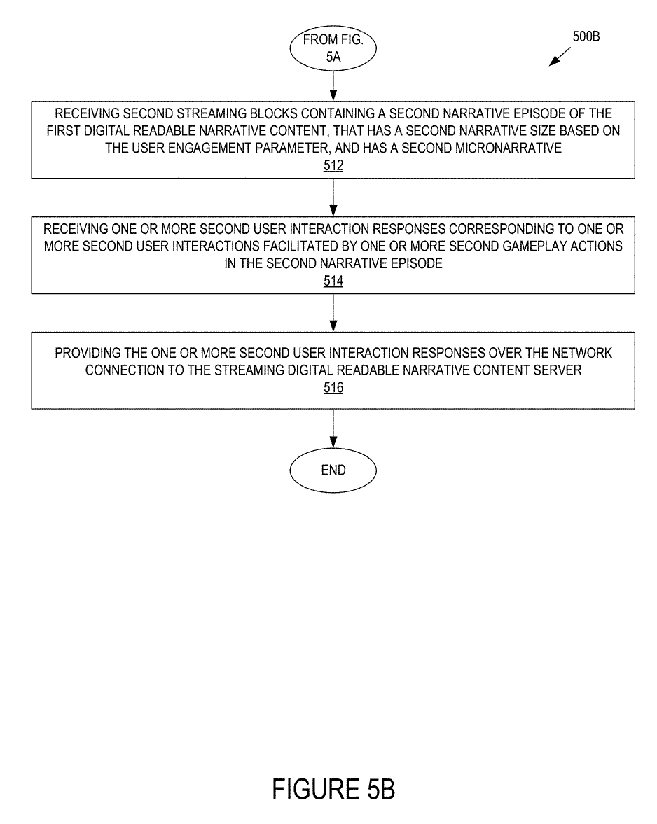

FIGS. 5A and 5B show a flowchart 500 of an example method of facilitating interactions one or more narrative episodes. The method is shown in conjunction with the structures of the narrative episode interactivity engine 110, shown in FIGS. 1 and 3 and discussed further herein. It is noted the method may have additional or fewer operations than those shown in FIGS. 5A and 5B. Additionally, it is noted that structures other than those shown in FIGS. 1 and 3 may perform the operations shown in FIGS. 5A and 5B.

At an operation 502, a narrative episode interaction application may be loaded into dynamic memory of a networked device. The NE application management engine(s) 308 may gather relevant data from the NE application management datastore 318 and may load a narrative episode interaction application into dynamic memory of the networked device(s) 108.

At an operation 504, a user engagement parameter representing a user engagement attribute of a user of the networked device may be gathered. In various implementations, the user engagement parameter gathering engine(s) 310 may gather from the user engagement parameter datastore 320 one or more user engagement parameters that represent user engagement attributes of a user of the networked device(s) 108.

At an operation 506, first streaming blocks containing a first narrative episode of first digital readable narrative content may be received. The first narrative episode may have a first narrative size and be associated with a first micronarrative. The streaming block management engine(s) 312 may receive a first narrative episode of digital readable narrative content. The first narrative episode may have a first narrative size and be associated with a first micronarrative. In some implementations, one or more attributes of the first narrative episode may be based on the user engagement parameters gathered by the user engagement parameter gathering engine(s) 310.

At an operation 508, the first narrative episode may be displayed in the narrative episode interaction application. The narrative episode display management engine(s) 314 may configure a display of the networked device(s) 108 to display the first narrative episode; in some implementations, including one or more virtual elements associated therewith. The user of the networked device(s) 108 may freely interact with the first narrative episode.

At an operation 510, one or more first user interaction responses corresponding to the one or more first user interactions facilitated by one or more first gameplay actions in the first narrative episode may be received. The user interaction response management engine(s) 316 may receive one or more first user interaction responses corresponding to the one or more first user interactions facilitated by one or more first gameplay actions in the first narrative episode.

At an operation 512, second streaming blocks containing a second narrative episode of first digital readable narrative content may be received. The second narrative episode may have a second narrative size and be associated with a second micronarrative. The streaming block management engine(s) 312 may receive a second narrative episode of digital readable narrative content. The second narrative episode may have a second narrative size and be associated with a second micronarrative. In some implementations, one or more attributes of the second narrative episode may be based on the user engagement parameters gathered by the user engagement parameter gathering engine(s) 310.

At an operation 514, one or more second user interaction responses corresponding to one or more second user interactions facilitated by one or more second gameplay actions in the second narrative episode may be received. The user interaction response management engine(s) 316 may receive one or more second user interaction responses corresponding to the one or more second user interactions facilitated by one or more second gameplay actions in the second narrative episode.

At an operation 516, the one or more second user interaction responses may be provided over the network connection to the streaming digital readable narrative content server. The user interaction response management engine(s) 316 may provide the one or more second user interaction responses over the computer network 104 to the streaming digital readable content system 106.

### Example Screens of a Narrative Episode Interaction Application

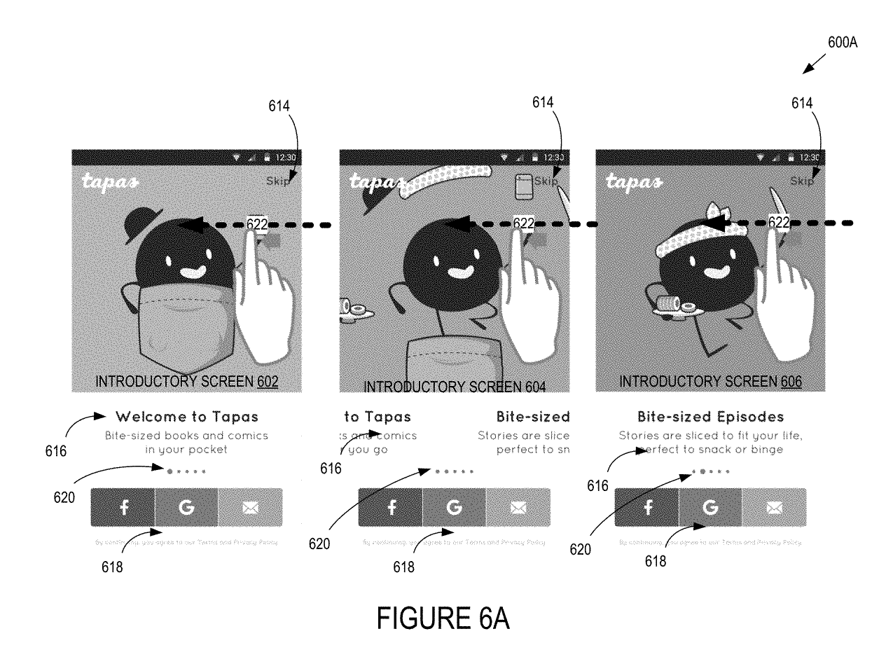

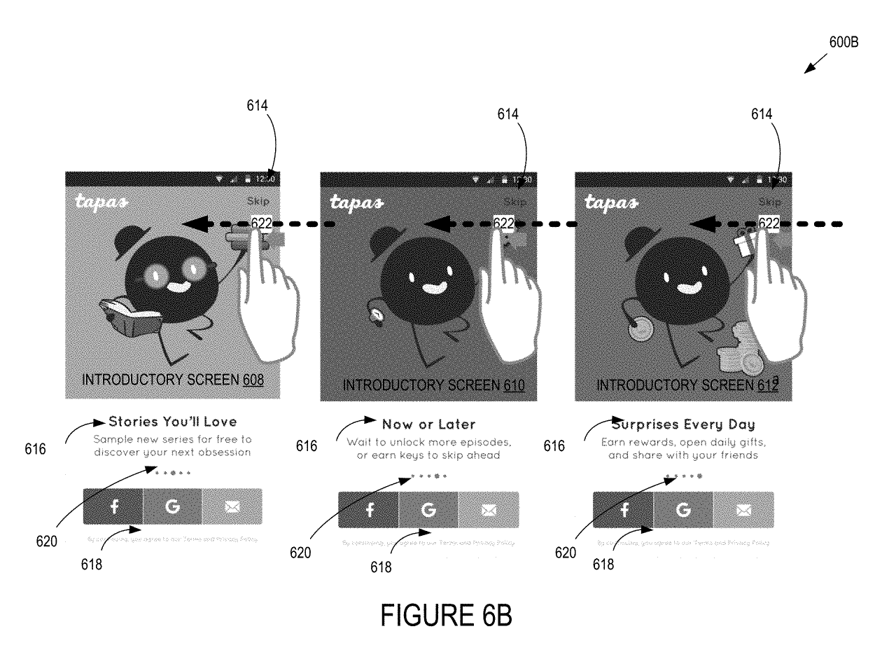

FIGS. 6A and 6B show examples 600A and 600B of introductory screens 602, 604, 606, 608, 610, and 612 of a narrative episode interaction application supported by the narrative episode interactivity engine 110. In various implementations, a user of the networked device 108 is guided to the introductory screens 602, 604, 606, 608, 610, and 612 when the user loads a narrative episode interaction application into memory of the narrative episode interactivity engine 110. Additionally, a user may be guided through the introductory screens 602, 604, 606, 608, 610, and 612 upon a specified gesture into the narrative episode interaction application. An example of such a gesture here is a left swipe gesture 622 that guides a user through, respectively, introductory screens 602, 604, 606, 608, 610, and 612.

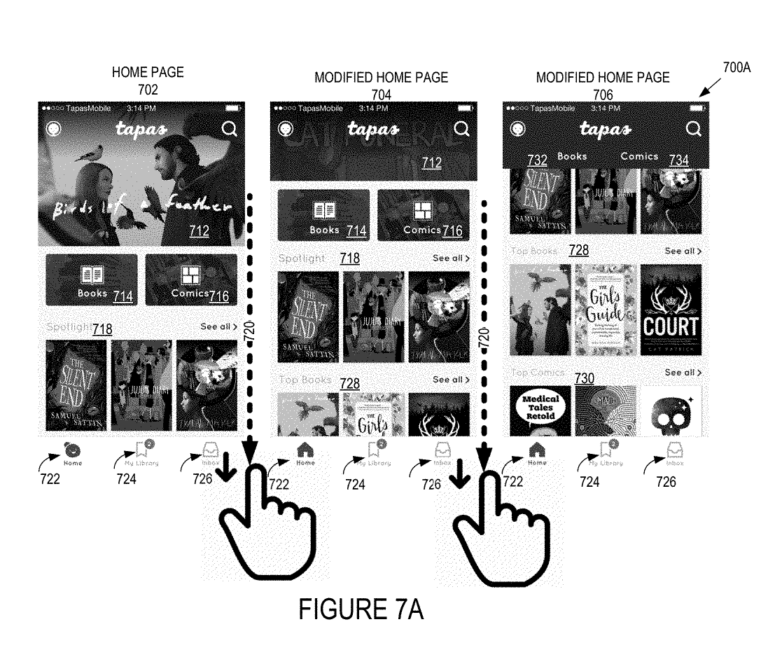

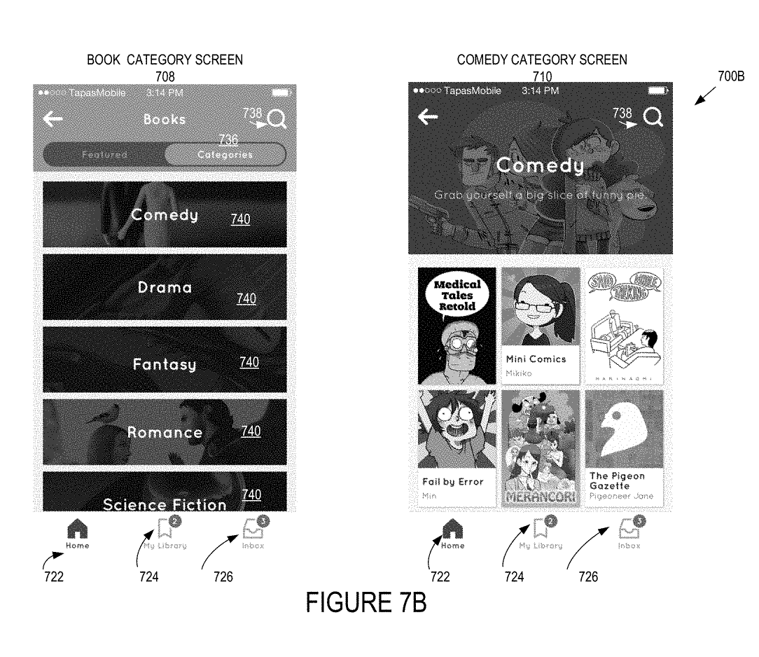

The introductory screens 602, 604, 606, 608, 610, and 612 may include a skip button 614, a splash text screen 616, sharing buttons 618, and a screen reference element 620. The skip button 614 may allow a user to exit the introductory screens 602, 604, 606, 608, 610, and 612, and may guide a user to another part of the narrative episode interaction application, such as content selection screens, library screens, user inbox screens, user profile screens, redemption screens, etc. In an implementation, selecting the skip button 614 guides a user to the home page screen 702, shown in FIG. 7A. The splash text screen 616 may display information relevant to the user. As examples, the splash text screen 616 may display welcome information (as shown in the introductory screen 602), promotional content (as shown in the transitional introductory screen 604, the introductory screen 606, the introductory screen 608, the introductory screen 610, and the introductory screen 612). The sharing buttons 618 may allow a user to send a link to download/install the narrative episode interaction application to contacts. In this example, the sharing buttons 618 allow a user to share a link to download/install the narrative episode interaction application over Facebook®, Gmail®, and email/Short Messaging Services (SMS).

FIGS. 7A and 7B show examples 700A and 700B of content selection screens of a narrative episode interaction application supported by the narrative episode interactivity engine 110. The content selection screens include a home page screen 702, a first modified home page screen 704, a second modified home page screen 706, a digital book category screen 708, and a comedy category screen 710.

In this example, the home page screen 702 may serve as a substantive point of entry into the narrative episode interaction application. The home page screen 702 may include a first promotional digital content title 712, a digital books link 714, a digital comics link 716, and additional promotional digital content titles 718. The home page screen 702 may further include a home tab 722, a my library tab 724, and an inbox tab 726. The first promotional digital content title 712 may guide the user to first promotional digital content, which in this example, is a digital comic entitled “Birds of a Feather.” The digital books link 714 may guide the user to digital books that the user can stream narrative episodes of. The digital comics link 716 may guide the user to digital comics the user can stream narrative episodes of. The additional promotional digital content titles 718 may guide the user to additional promotional digital readable narrative content, which in this example include the digital books “The Silent End,” Juju's Diary,” and “Twin Maker.” The home tab 722 may allow the user to return to the home page screen 702. The my library tab 724 may guide the user to the user's library of digital readable narrative content, e.g., titles which the user has already unlocked, purchased, etc. The inbox tab 726 may guide the user to an inbox for in-application messages.

The home page screen 702 may be displayed when the user has exited the introductory screens 602, 604, 606, 608, 610, and 612, by swiping through those screens and/or by selecting the skip button 614. In some implementations, the home page screen 702 may receive a gesture, e.g., a downward swipe 720. The downward swipe 720 may cause the home page screen 702 to scroll downward and/or display the first modified home page screen 704. The first modified home page screen 704 may include, in addition to the content shown in the home page screen 702, a top books section 728, which in turn may include a list of new, popular, recently added, etc. digital books. The downward swipe 720 may cause a user to be guided to the second modified home page screen 706, which includes a top comics section 730, which in turn may include a list of new, popular, recently added, etc. digital comics.

The digital book category screen 708 may display specific digital books and/or categories of digital books. In some implementations, a user may be guided to the digital book category screen 708 upon selection of the digital books link 714. The digital book category screen 708 may include a categories tab 736 that displays one or more digital book categories 740. The digital book category screen 708 may further include a search button 738 that allows a user to search for digital readable narrative content. The comedy category screen 710 may be displayed when a user selects a specific one of the digital book categories 740 (e.g., the comedy category). In this example, the comedy category screen 710 includes a set of comedic digital books.

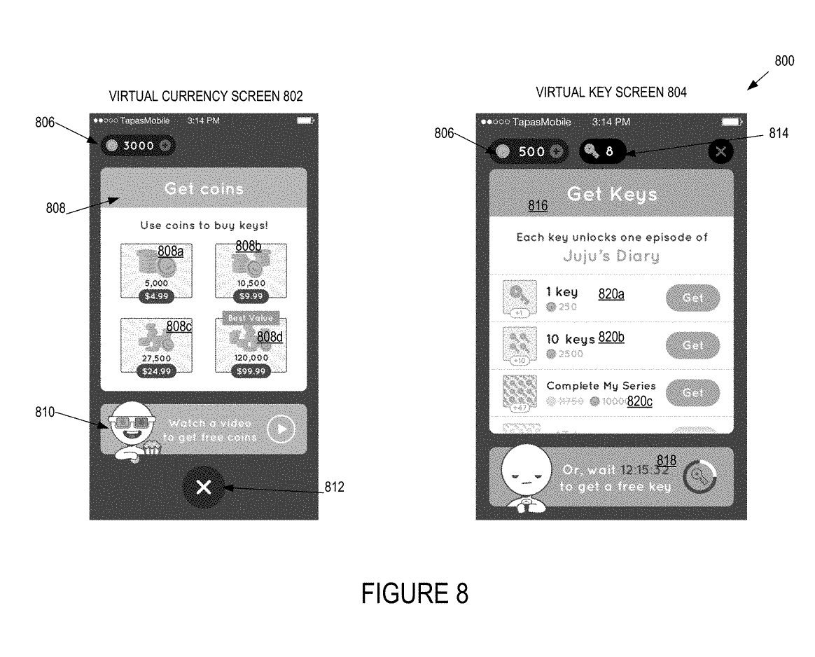

FIG. 8 shows examples 800 of a virtual currency screen 802 and a virtual key screen 804 of a narrative episode interaction application. A user may be guided to the virtual currency screen 802 and/or the virtual key screen 804 when the user logs into the narrative episode interaction application or selects one or more buttons/links/etc. displayed therein. The virtual currency screen 802 may include a virtual currency amount area 806, a virtual currency purchase area 808, a virtual currency promotional area 810, and an exit button 812. The virtual currency amount area 806 may display an amount of virtual currency associated with a user. The virtual currency purchase areas 808a, 808b, 808c, and 808d may allow a user to purchase virtual currency; in this example, these purchases are facilitated through a mobile application store, but the purchases could be facilitated in any relevant way. The virtual currency promotional area 810 may provide a link for a user to obtain additional virtual currency by taking an action, such as viewing an advertisement or promotional video. The exit button 812 may allow the user to exit the virtual currency screen 802.

The virtual key screen 804 may include the virtual currency amount area 806, a virtual key amount area 814, virtual key purchase areas 816, and a virtual key promotional area 818. The virtual currency amount area 806 may display an amount of virtual currency associated with a user. The virtual key amount area 814 may display an amount of virtual keys associated with a user. The virtual key promotional area 818 may provide a link for a user to obtain additional virtual keys by taking an action; here, the virtual key promotional area 818 will provide a free virtual key to the user after approximately twelve hours. Virtual key offers 820a, 820b, and 820c may be displayed.

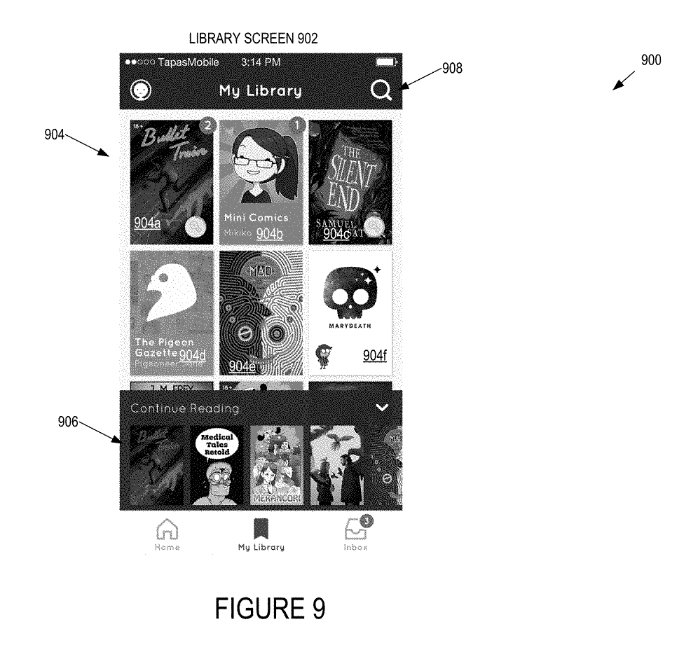

FIG. 9 shows an example 900 of a library screen of a narrative episode interaction application. The library screen may include a digital readable narrative content area 904, a reading list 906, narrative episode summary indicators 908. The digital readable narrative content area 904 may be configured to display readable narrative content that a user already has access to, whether by purchase, by unlocking, or otherwise. In this example, the digital readable narrative content area 904 includes digital readable narrative content items 904a, 904b, 904c, 904d, 904e, and 904f. The digital readable content in the digital readable narrative content area 904 need not correspond only to the titles and/or episodes a user has unlocked. As an example, in FIG. 9, the user has unlocked two episodes of digital readable narrative content item 904a, a single episode of digital readable narrative content item 904b, and has not unlocked digital readable narrative content items 904c, 904d, 904e, or 904f. The reading list 906 may provide the user with a list of digital readable narrative content that the user has already started reading. The narrative episode summary indicators 908 may include narrative episodes that the user has already unlocked, and, as a result, has access to.

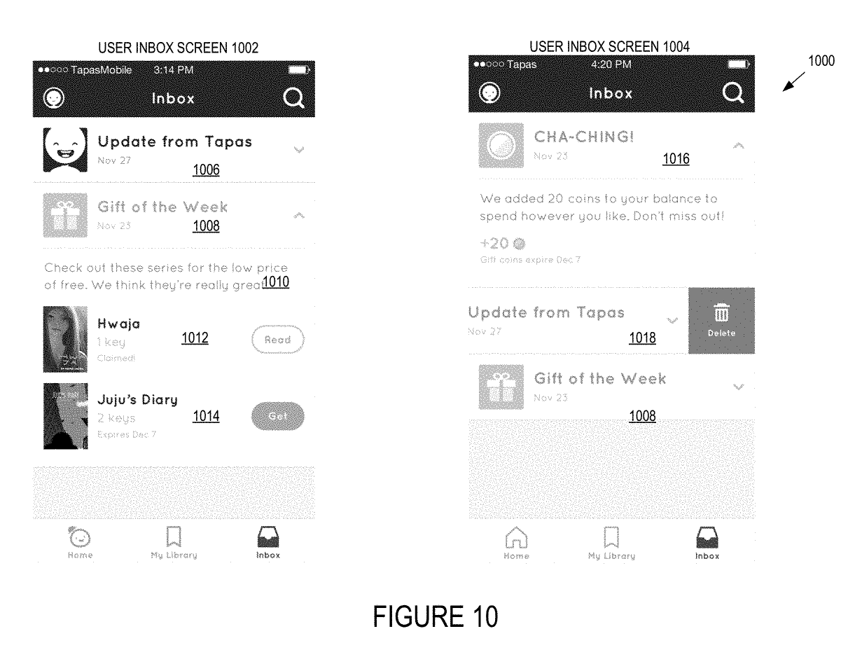

FIG. 10 shows examples 1000 of user inbox screens 1002 and 1004 of a narrative episode interaction application. The user inbox screen 1002 may include an update area 1006, a gift area 1008, and promotional area 1010, including a first promotional digital readable narrative content item 1012, and a second promotional digital readable narrative content item 1014. In this example, the update area 1006 may provide updates from the narrative episode interaction application. The gift area 1008 may include a link to gifts of virtual items, virtual currencies, virtual keys, etc. from other users or from the narrative episode interaction application. The first promotional digital readable narrative content item 1012 has been read in this example, and was previously claimed with a single virtual key. The second promotional digital readable narrative content item 1014 has not been read, and may be claimed with two virtual keys; the offer for second promotional digital readable narrative content item 1014 expires on December 7. The user inbox screen 1004 may be loaded when a user selects the update area 1006. The user inbox screen 1004 shows account updates 1016 and news updates 1018. In this example, the user inbox screen 1004 has expanded when the user selected the update area 1006.

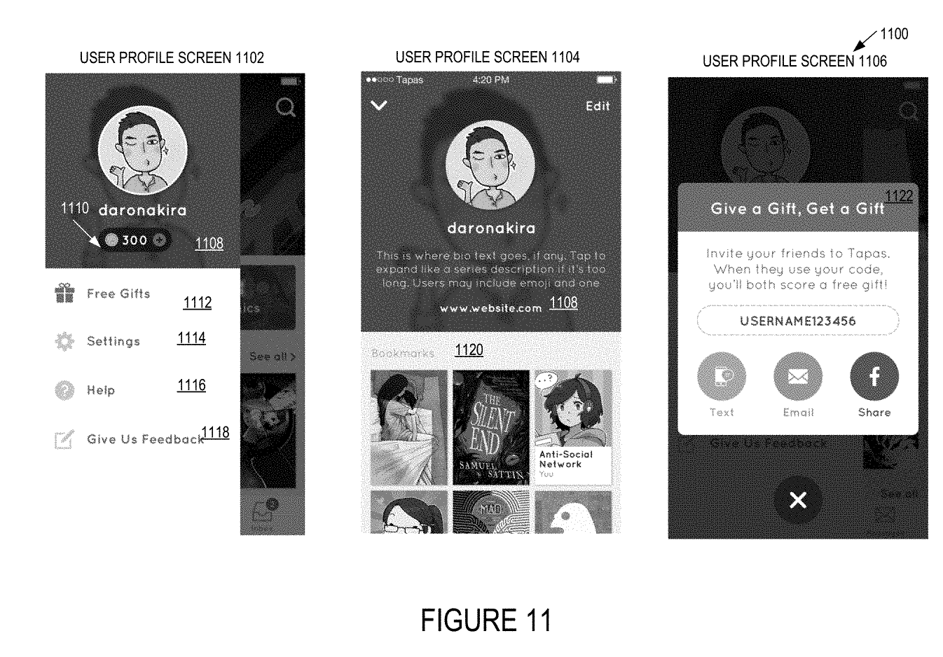

FIG. 11 shows examples 1100 of user profile screens 1102, 1104, and 1106 of a narrative episode interaction application. The user profile screen 1102 may include a user summary area 1108, a virtual currency amount 1110, a gift area 1112, a settings area 1114, a help area 1116, and a feedback area 1118. The user profile screen 1104 may include the user summary area 1108 and a bookmarks area 1120, which lists narrative episodes of digital readable narrative content the user has access to. The user profile screen 1106 may include a gift giving screen 1122 that allows the user to give another user gifts of virtual items. The gift giving screen 1122 may send a code to another user for the virtual item.

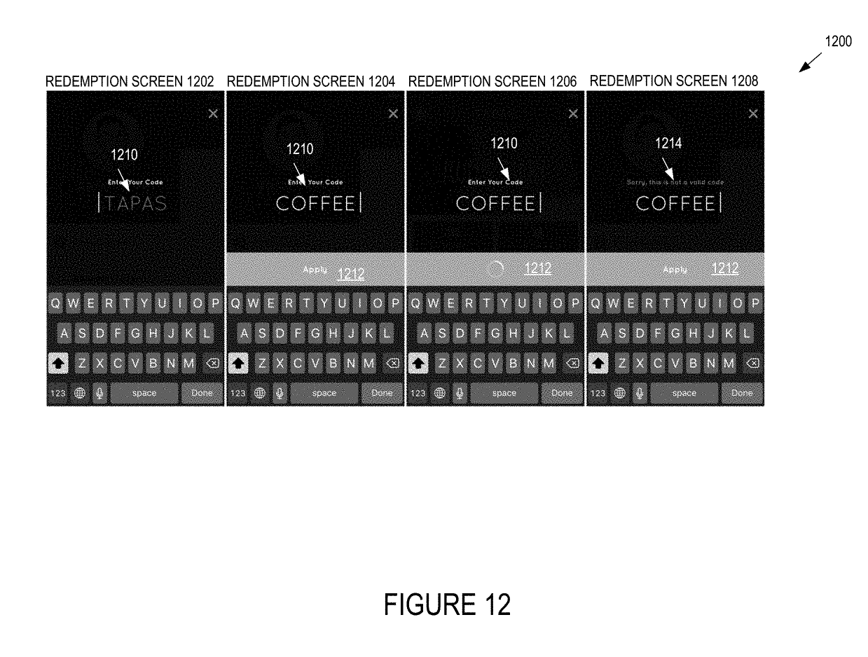

FIG. 12 shows examples 1200 of redemption screens 1202, 1204, 1206, and 1208 of a narrative episode interaction application. The redemption screens 1202, 1204, 1206, and 1208 may be used to redeem a code for a virtual item. The redemption screens 1202, 1204, 1206, and 1208 include a code entry field 1210, a code analysis button 1212, and, in this case, an error message 1214.

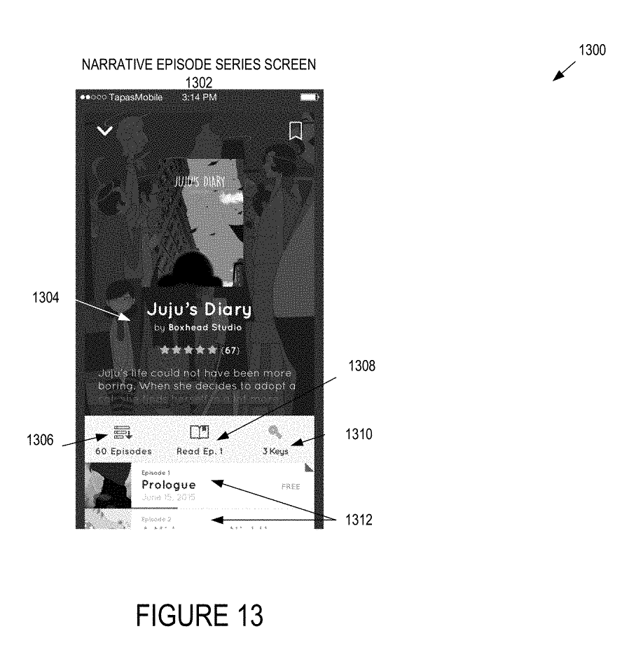

FIG. 13 shows an example 1300 of a narrative episode series screen 1302 of a narrative episode interaction application. The narrative episode series screen 1302 may include a title area 1304, a narrative episode table of contents 1306, a narrative episode reading button 1308, a key listing button 1310, and a narrative episode list 1312. The title area 1304 may provide a title and/or other information related to specific digital readable narrative content. The narrative episode table of contents 1306 may list narrative episodes of the specific digital readable narrative content. The narrative episode reading button 1308 may allow a user to read a specific narrative episode. The key listing button 1310 may allow the user to list the number of virtual keys the user has. The narrative episode list 1312 may list the narrative episodes of the specific digital readable narrative content.

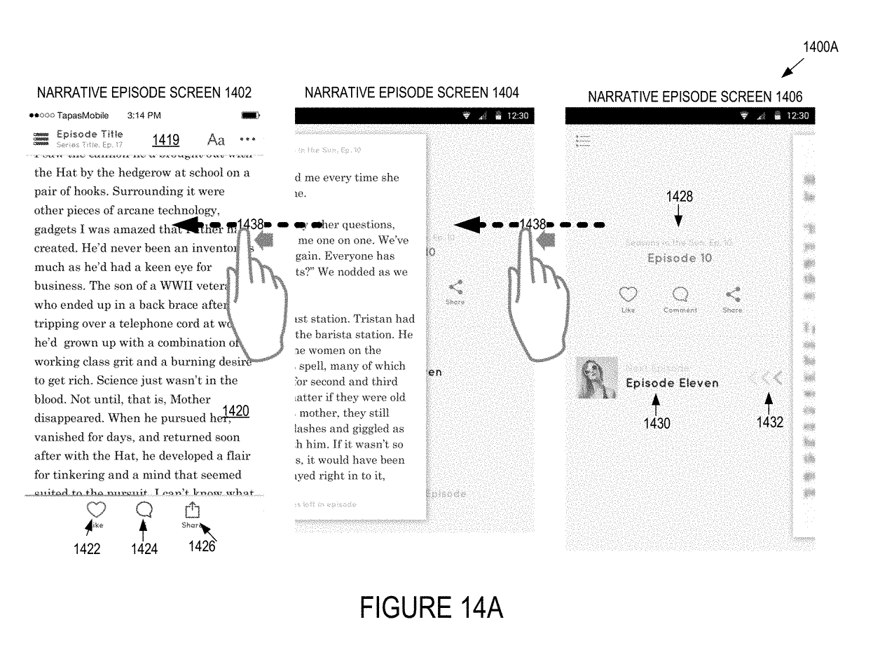

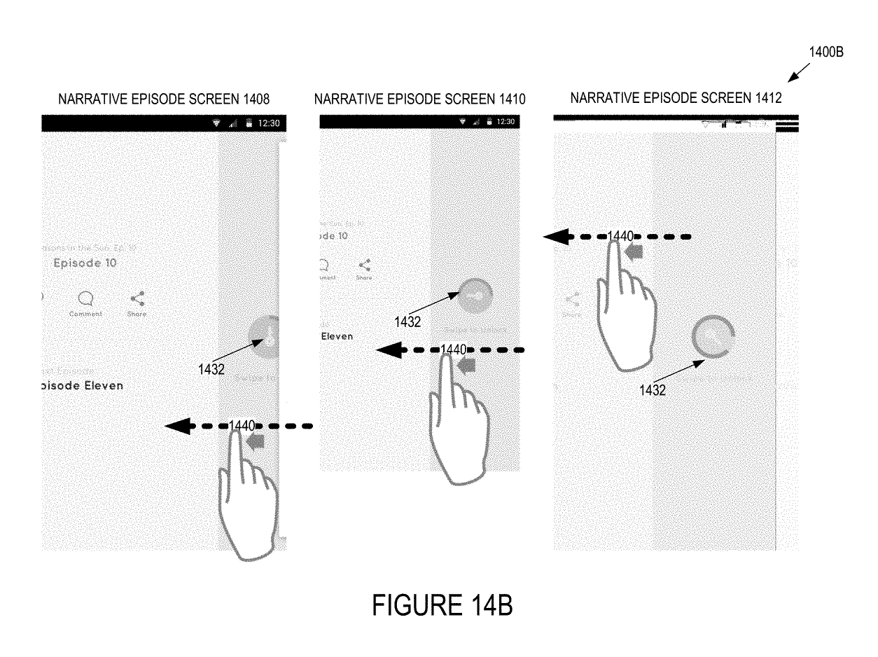

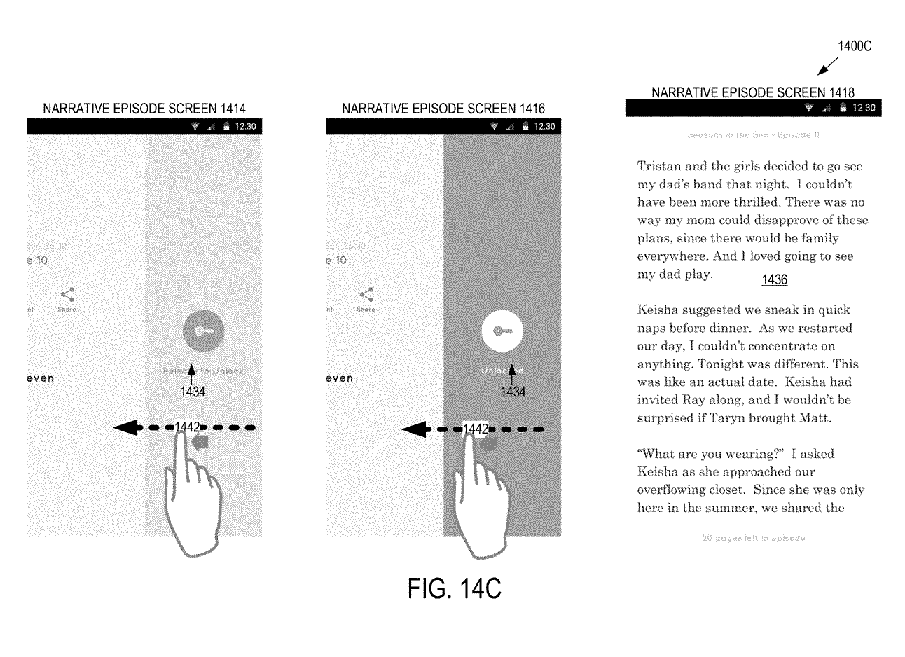

FIGS. 14A, 14B, and 14C show examples 1400A, 1400B, and 1400C of narrative episode screens 1402, 1404, 1406, 1408, 1410, 1412, 1414, 1416, and 1418, including mechanics to move through narrative episodes, of a narrative episode interaction application. The narrative episode screens 1402, 1404, 1406, 1408, 1410, 1412, 1414, 1416, and 1418 include a narrative episode title area 1419, a first content area 1420, a like button 1422, a comment button 1424, a share button 1426, a first narrative episode splash screen 1428, a second narrative episode splash screen 1430, a first virtual item unlocking element 1432, a second virtual item unlocking element 1434, and a second content area 1436.

The narrative episode title area 1419 may include a text box that provides a title of a narrative episode. The first content area 1420 may include a text box that provides the specific digital content of a first narrative episode. The like button 1422, comment button 1424, and share button 1426 may support liking, commenting, sharing, etc. related to narrative episodes. The first narrative episode splash screen 1428 may provide details of the first narrative episode, and may appear when the user has finished reading the first narrative episode. The second narrative episode splash screen 1430 may provide an introduction to a second narrative episode. The first virtual item unlocking element 1432 may comprise an arrow and a virtual item (e.g., here a virtual lock) that can be swiped to reveal details of the second narrative episode and/or facilitate unlocking of the second narrative episode. The second virtual item unlocking element 1434 may comprise a virtual item that can be swiped to facilitate access to the second narrative episode; in this example, the second virtual item unlocking element 1434 is shown only once the second narrative episode has been revealed with user interaction with the first virtual item unlocking element 1432.

Also shown in the examples 1400A, 1400B, and 1400C are a first gesture 1438, a second gesture 1440, and a third gesture 1442. Each of the first gesture 1438, the second gesture 1440, and the third gesture 1442 may comprise a left swipe gesture. In this example, the first gesture 1438 comprises a left swipe against the first narrative episode to signify the user has finished reading the first narrative episode. The second gesture 1440 comprises a request to interact with the first virtual item unlocking element 1432 and facilitate unlocking of the second narrative episode. The third gesture 1442 may comprise a request to interact with the second virtual item unlocking element 1434 an actually unlock the second narrative episode.

### Example Computer System and Additional Legal and Factual Considerations

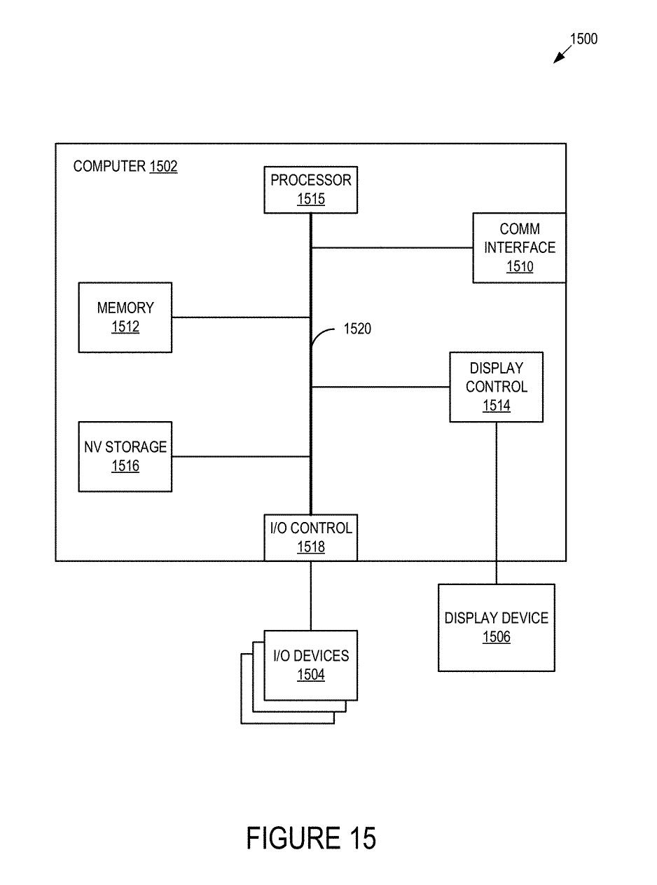

FIG. 15 shows a computer system 1500, according to some embodiments. (Any “computer system” referred to herein may have one or more of the components of the computer system 1500 shown in FIG. 15.) The computer system 1500 may be a conventional computer system that may be used as a client computer system, such as a wireless client or a workstation, or a server computer system. The computer system 1500 includes a computer 1502, I/O devices 1504, and a display device 1506. The computer 1502 includes a processor 1515, a communications interface 1510, memory 1512, display controller 1514, non-volatile storage 1516, and I/O controller 1518. The computer 1502 may be coupled to or include the I/O devices 1504 and display device 1506.

The computer 1502 interfaces to external systems through the communications interface 1510, which may include a modem or network interface. It will be appreciated that the communications interface 1510 may be considered to be part of the computer system 1500 or a part of the computer 1502. The communications interface 1510 may be an analog modem, ISDN modem, cable modem, token ring interface, satellite transmission interface (e.g. “direct PC”), or other interfaces for coupling a computer system to other computer systems.

The processor 1515 may be, for example, a conventional microprocessor such as an Intel Pentium microprocessor or Motorola power PC microprocessor. The memory 1512 is coupled to the processor 1515 by a bus 1520. The memory 1512 may be Dynamic Random Access Memory (DRAM) and may also include Static RAM (SRAM). The bus 1520 couples the processor 1515 to the memory 1512, also to the non-volatile storage 1516, to the display controller 1514, and to the I/O controller 1518.

The I/O devices 1504 may include a keyboard, disk drives, printers, a scanner, and other input and output devices, including a mouse or other pointing device. The display controller 1514 may control in the conventional manner a display on the display device 1506, which may be, for example, a cathode ray tube (CRT) or liquid crystal display (LCD). The display controller 1514 and the I/O controller 1518 may be implemented with conventional well-known technology.

The non-volatile storage 1516 is often a magnetic hard disk, an optical disk, or another form of storage for large amounts of data. Some of this data is often written, by a direct memory access process, into memory 1512 during execution of software in the computer 1502. One of skill in the art will immediately recognize that the terms “machine-readable medium” or “computer-readable medium” includes any type of storage device that is accessible by the processor 1515 and also encompasses a carrier wave that encodes a data signal.

The computer system 1500 is one example of many possible computer systems that have different architectures. For example, personal computers based on an Intel microprocessor often have multiple buses, one of which may be an I/O bus for the peripherals and one that directly connects the processor 1515 and the memory 1512 (often referred to as a memory bus). The buses are connected together through bridge components that perform any necessary translation due to differing bus protocols.

Network computers are another type of computer system that may be used in conjunction with the teachings provided herein. Network computers do not usually include a hard disk or other mass storage, and the executable programs are loaded from a network connection into the memory 1512 for execution by the processor 1515. A Web TV system, which is known in the art, is also considered to be a computer system, but it may lack some of the features shown in FIG. 15, such as certain input or output devices. A typical computer system will usually include at least a processor, memory, and a bus coupling the memory to the processor.

Though FIG. 15 shows an example of the computer system 1500, it is noted that the term “computer system,” as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor may be, for example, a general-purpose central processing unit (CPU), such as a microprocessor, or a special-purpose processor, such as a microcontroller.

The memory may include, by way of example but not limitation, random access memory (RAM), such as dynamic RAM (DRAM) and static RAM (SRAM). The memory may be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. §101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus may also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage may be local, remote, or distributed. The non-volatile storage is optional because systems may be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used in this paper, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, the computer system 1500 may be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus 1520 may also couple the processor 1515 to the communications interface 1510. The communications interface 1510 may include one or more input and/or output (I/O) devices. The I/O devices may include, by way of example but not limitation, a keyboard, a mouse or other pointing device, disk drives, printers, a scanner, and other I/O devices, including a display device. The display device 1506 may include, by way of example but not limitation, a cathode ray tube (CRT), liquid crystal display (LCD), or some other applicable known or convenient display device. The communications interface 1510 may include one or more of a modem or network interface. It will be appreciated that a modem or network interface may be considered to be part of the computer system 1500. The communications interface 1510 may include an analog modem, ISDN modem, cable modem, token ring interface, satellite transmission interface (e.g. “direct PC”), or other interfaces for coupling the computer system 1500 to other computer systems. The communications interfaces 1510 may enable computer systems and other devices to be coupled together in a network.

Several components described in this paper, including clients, servers, and engines, may be compatible with or implemented using a cloud-based computing system. As used in this paper, a cloud-based computing system is a system that provides computing resources, software, and/or information to client devices by maintaining centralized services and resources that the client devices may access over a communication interface, such as a network. The cloud-based computing system may involve a subscription for services or use a utility pricing model. Users may access the protocols of the cloud-based computing system through a web browser or other container application located on their client device.

This paper describes techniques that those of skill in the art may implement in numerous ways. For instance, those of skill in the art may implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

A detailed description of one or more implementations of the invention is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus may be specially constructed for the required purposes, or it may comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided.

What is claimed is:

1. A method being implemented by a computing system including one or more physical processors and storage media storing machine-readable instructions, the method comprising:
gathering digital readable narrative content, the digital readable narrative content comprising written narrative materials for display in a digital format and further comprising a macronarrative;
gathering a user engagement parameter for the digital readable narrative content, the user engagement parameter representing an engagement attribute of a user of a networked device with the digital readable narrative content;
selecting a first narrative episode within the digital readable narrative content, the first narrative episode comprising a first micronarrative, the first micronarrative being part of the macronarrative, and the first narrative episode having a first narrative size, the first narrative size being based on the user engagement parameter;
associating one or more first gameplay actions with the first narrative episode, the one or more first gameplay actions facilitating one or more first user interactions with the first narrative episode; and
creating first streaming blocks containing the first narrative episode to facilitate streaming the first narrative episode to the networked device.

2. The method of claim 1, further comprising streaming the first narrative episode to the networked device.

3. The method of claim 1, wherein the first narrative size is based on one or more of a memory constraint of the networked device, a first estimated user engagement time of the user, and a first actual user engagement time of the user.

4. The method of claim 1, wherein the one or more first gameplay actions are selected based on attributes of the first micronarrative.

5. The method of claim 1, wherein the one or more first gameplay actions comprise one or more of: starting to read a portion of the first narrative episode, finishing reading a portion of the first narrative episode, and annotating a portion of the first narrative episode.

6. The method of claim 1, wherein the one or more first gameplay actions comprise achieving a non-reading milestone in the first narrative episode.

7. The method of claim 1, wherein the one or more first gameplay actions modify an episode state of the first narrative episode.

8. The method of claim 1, further comprising:
receiving one or more first user interaction responses corresponding to the one or more first user interactions facilitated by the one or more first gameplay actions from the networked device; and
selecting, based on the one or more first user interaction responses, a second narrative episode within the digital readable narrative content, the second narrative episode comprising a second micronarrative, the second micronarrative being part of the macronarrative, the second narrative episode having a second narrative size, and the second narrative size being based on the user engagement parameter.

9. The method of claim 8, further comprising:
associating one or more second gameplay actions with the second narrative episode, the one or more second gameplay actions facilitating one or more second user interactions with the second narrative episode; and
creating second streaming blocks containing the second narrative episode to facilitate streaming the second narrative episode to the networked device.

10. The method of claim 8, wherein the first narrative episode and the second narrative episode form a sequence of narrative episodes, the sequence including a virtual transitional element to transition from the first micronarrative to the second micronarrative.

11. The method of claim 8, wherein the second narrative size is based on one or more of a memory constraint of the networked device, a second estimated user engagement time of the user, a second actual user engagement time of the user, and the one or more first user interaction responses.

12. The method of claim 8, wherein the one or more second gameplay actions are selected based on attributes of the second micronarrative.

13. The method of claim 8, wherein the one or more first user interaction responses comprise one or more requests to perform a virtual unlocking of the second narrative episode.

14. The method of claim 13, wherein the one or more requests to perform the virtual unlocking comprise requests to redeem virtual goods or virtual currency.

15. The method of claim 13, wherein the one or more requests to perform the virtual unlocking comprise one or more requests to buy the second virtual episode.

16. The method of claim 15, wherein the one or more requests to buy the second virtual episode comprise one or more requests to spend digital currencies or one or more requests to spend real-life currencies.

17. The method of claim 1, wherein the networked device comprises one or more of a desktop computer, a laptop computer, a tablet computing device, and a mobile phone.

18. The method of claim 1, wherein the digital readable narrative content comprises a digital book or a digital comic.

19. A system comprising:
at least one processor; and
a memory storing instructions configured to instruct the at least one processor to perform:
gathering digital readable narrative content, the digital readable narrative content comprising written narrative materials for display in a digital format and further comprising a macronarrative;
gathering a user engagement parameter for the digital readable narrative content, the user engagement parameter representing an engagement attribute of a user of a networked device with the digital readable narrative content;
selecting a first narrative episode within the digital readable narrative content, the first narrative episode comprising a first micronarrative, the first micronarrative being part of the macronarrative, and the first narrative episode having a first narrative size, the first narrative size being based on the user engagement parameter;
associating one or more first gameplay actions with the first narrative episode, the one or more first gameplay actions facilitating one or more first user interactions with the first narrative episode; and
creating first streaming blocks containing the first narrative episode to facilitate streaming the first narrative episode to the networked device.

20. A computer storage medium storing computer-executable instructions that, when executed, cause a computer system to perform a computer-implemented method comprising:
gathering digital readable narrative content, the digital readable narrative content comprising written narrative materials for display in a digital format and further comprising a macronarrative;
gathering a user engagement parameter for the digital readable narrative content, the user engagement parameter representing an engagement attribute of a user of a networked device with the digital readable narrative content;
selecting a first narrative episode within the digital readable narrative content, the first narrative episode comprising a first micronarrative, the first micronarrative being part of the macronarrative, and the first narrative episode having a first narrative size, the first narrative size being based on the user engagement parameter;
associating one or more first gameplay actions with the first narrative episode, the one or more first gameplay actions facilitating one or more first user interactions with the first narrative episode; and
creating first streaming blocks containing the first narrative episode to facilitate streaming the first narrative episode to the networked device.
